(19) United States
(12) Patent Application Publication
(10) Pub. No.: US 2017/0284293 A1
(43) Pub. Date: Oct. 5, 2017

(54) HEAT SHIELD AND PART SHIELDED WITH SUCH A HEAT SHIELD

(71) Applicant: REINZ-DICHTUNGS-GMBH, NEU-ULM (DE)

(72) Inventor: HELMUT OSTERMEIER, TIEFENBACH (DE)

(73) Assignee: REINZ-DICHTUNGS-GMBH, NEU-ULM (DE)

(21) Appl. No.: 15/507,273

(22) PCT Filed: Aug. 28, 2015
(86) PCT No.: PCT/EP2015/069738

§ 371 Date: Feb. 28, 2017

(30) Foreign Application Priority Data
Sep. 1, 2014 (DE) 20 2014 006 987.5

(51) Int. Cl. F02B 77/11; B32B 5/06; B32B 7/08; B32B 15/14; B32B 3/04; B32B 3/06; B32B 3/26; F16L 59/02; B32B 7/12

(52) U.S. Cl. CPC F02B 77/11; F16L 59/029; F16L 59/028; F16L 59/021; B32B 5/06; B32B 7/08; B32B 7/12; B32B 3/04; B32B 3/06; B32B 3/26; B32B 15/14; F16L 59/02; B32B 5/02

(57) ABSTRACT

The present invention relates to a heat shield for shielding of hot areas, such as hot areas of a combustion engine as well as a part that is shielded with such a heat shield. The heat shield for shielding of hot areas, e. g. of a combustion engine, with at least one metal sheet layer, characterized in that the insulating layer comprises a metallic grid, which is embedded into a fiber mat.

The present invention relates to a heat shield for shielding of hot areas, such as hot areas of a combustion engine as well as a part that is shielded with such a heat shield.

Heat shields, e.g. in engines of vehicles, in particular in the area of the exhaust line, serve for the protection of temperature-sensitive parts and assemblies which are located close to hot parts against non-admissible heating. Doing so, the heat shields also improve the sound protection.

Usually, heat shields are three-dimensionally shaped structural parts, which comprise at least one metal sheet layer. The three-dimensional shape of the at least one metal sheet layer usually results from the shape of the parts to be shielded against each other and their respective distance.

A heat shield thus comprises at least one or several metal sheet layer(s), which form the contour of the heat shield. Between individual metal sheet layers or adjacent to one of the metal sheet layer(s), an additional insulating layer can be arranged. One usually uses compressed particle-based layers, such as mica and/or graphite layers or temperature-stable fleece, such as glass fiber or mineral fiber fleece as this insulating layer.

If only one metal sheet layer is used, then an insulating layer can be provided between the part to be shielded and the metallic layer. This insulating layer is arranged adjacent to the metallic layer of the heat shield. In the state of the art, one uses for instance glass fiber fleece or mineral fiber fleece as such insulating layers. As they are arranged adjacent to the three-dimensionally shaped metallic layer, they are shaped in the likeness of this three-dimensional shape, too. Such shaped glass fiber mats are however very costly and very laborious in their production. In particular, these shaped fiber mats of the state of the art comprise a high percentage of binder, which moreover penetrates the shaped fiber mat to a large share of its thickness, often over the entire area. This causes that the cross-linking or curing of the binder is very demanding in time and energy.

Proceeding from this state of the art, it is the object of the present invention to provide a heat shield as well as a shielded part with such a heat shield, which heat shield comprises at least one metal sheet layer and an insulating layer adjacent to the metal sheet layer, which—compared to the state of the art—can be produced simpler and more cost-efficient and which heat shield in addition can be mounted in a secure manner.

This object is solved by the heat shield according to claim 1 and the shielded part according to claim 21. Advantageous embodiment of the heat shield according to the invention are given in the dependent claims.

The heat shield according to the invention for the shielding of hot areas, e.g. of a combustion engine, comprises one metal sheet layer. Further metal sheet layers are possible, but not required. An insulating layer is arranged adjacent to the metal sheet layer. Thus, the heat shield according to the invention comprises an at least two-layered structure with one metal sheet layer and an insulating layer. If the heat shield is arranged in such a way that the insulating layer is arranged on the part to be shielded, then a direct insulation of the part to be shielded by the insulating layer is achieved. As an alternative, the insulating layer may also be laminated with a metal sheet layer, in particular with a metal foil, so that a sandwich-construction of the heat shield results.

According to the invention, the insulating layer comprises a fiber mat, with an additional metallic grid being embedded into this fiber mat.

With the embedding of the metallic grid, the fiber mat, which as such is not stable in its shape, can be permanently shaped and be adapted to the 3-dimensional shape of the metal sheet layer. This on the one hand makes it then possible to transport the insulating layer in its formed shape and to attach it to the metal sheet layer. On the other hand, it is also possible to join the 2-dimensional insulation layer with embedded metallic grid to the metal sheet layer in its 2-dimensional state and to deform both of them together to their 3-dimensional shape.

Such an insulating layer for a heat shield can be produced in a much simpler way and therefore more cost-efficient then the 3-dimensionally shaped glass fiber mats already known in the state of the art.

For a large variety of applications, the metallic grid is embedded into the fiber mat, so that the metallic grid during the mounting of the heat shield shows no contact with the part to be shielded and/or the metal sheet layer or all metal sheet layers of the heat shield. With this, a heat transfer trough the heat shield across its thickness is avoided. However, for some applications, it is also possible that the metal grid is located at or reaches till the outer surface of the insulating layer facing the object to be shielded provided that the metal grid does not penetrate the entire thickness of the insulating layer. In this case, it is even preferred if it penetrates only a small share of the thickness of the insulating layer, e.g. less than 50%. This way, the heat is only transferred from the part to be shielded to the metal grid but not further through the insulating layer. As a consequence, a heat transfer transverse the thickness of the heat shield is avoided, too.

It is particularly advantageous if the metallic grid relative to the respective local thickness of the fiber mat is arranged distanced to the surface of the fiber mat facing the metal sheet layer by at least 5%, advantageously at least 8%, further, advantageously be at least 10%. As an alternative or additionally, the metallic grid relative to the respective local thickness of the fiber mat is arranged distanced to the surface pointing away from the metal sheet layer, thus usually to the surface of the fiber mat immediately adjacent to the part to be shielded, by at least 35%, preferably by at least 45%, further preferably at least 50% of the thickness of the fiber mat. An arrangement of the metallic grid in the center of the fiber mat relative to the respective local thickness of the fiber mat is particularly preferred.

In other words, the grid shall be arranged in an area that is distanced from the metal sheet layer by between 8% and 65% of the respective local thickness of the fiber mat.

Such an embedding of the metallic grid into the fiber mat is achieved in a particularly preferred manner in that at least a part of the fibers of the fiber mat penetrate the passage openings of the metallic grid completely. This can advantageously be realized as fiber pile or as fiber loop, with the fibers of the pile or the loops penetrating the passage openings orthogonal or essentially orthogonal to its facial extension or being interwoven with the metallic grid.

The fibers can additionally be connected to the metallic grid adhesively, especially glued. As an alternative, the metallic grid prior to the curing of a binder is embedded into a fiber mat and after the curing of the adhesive connection is held between the fibers in this fiber composite. Such a gluing, e.g. using a binder, can also be realized in individual areas, e.g. at the edge areas of the fiber mat, in particular as a sealing of the edge, and/or in areas close to the surface. The share of the binder preferably should amount to 25%, preferably 10%, preferably 5% of the total weight of the fiber mat. In the ideal case, the fiber mat does however comprise no binder. It is also possible to vary the share of binder in different areas of the fiber mat or to combine different fiber layers with different binder content.

In order to achieve a sufficient heat insulation, the thickness of the fiber mat advantageously amounts to between 4.5 and 15 mm (in each case including or excluding the limits), preferably between 6 mm and 12 mm, further preferably between 7 mm and 12 mm (in each case including or excluding the limits).

A fiber weave, in particular a loop fabric or a cut pile, a knitted fabric, a warp knitted fabric, a roving or a fleece is suited as fiber mat. Further techniques for the production of the fiber mat can be thought of. If a pile is used as fiber mat, then the density of the fibers preferably ranges between 9 fiber threads/cm² and 100 fiber threads/cm² (in each case including or excluding the limits). If a loop fabric is used as fiber mat, then the density of the fibers preferably ranges between 2 loops/cm² and 30 loops /cm², preferably between 9 loops/cm² and 16 loops /cm² (in each case including or excluding the limits). Such a design of the fiber mat is sufficiently stiff in order to maintain its shape and to simultaneously embed the metallic grid in a secure manner. Further, this avoids too high a density in fibers or loops, which would cause a reduced heat insulation.

As fibers, glass fibers, mineral fibers and/or carbon fibers, including combinations of these fibers are suited for the fiber mat. The length of the fibers here is adapted to the respective use. Regardless of whether they are used with or without a binder, the fibers can be impregnated in order to modify their behavior e.g. with respect to oil.

The fibers of the fiber mat are particular stable with respect to their shape if they comprise one or several metallic fiber(s) as core of the fiber. This can be provided for one, several or all fibers of a fiber mat. It is easier to penetrate the openings of the metallic grid for such reinforced fibers. Moreover, they can be bent in a pressing- or embossing process at the ends of their fibers in such a way that they reach beyond the bridges of the metallic grid and this way grip the metallic grid.

As an alternative or additionally, metallic hooks can protrude from the metallic grid, which on their own reach beyond the fibers of the fiber mat. In this respect one has to ascertain that the hooks do protrude only to such a degree from the plane of extension of the metallic grid, that they are still embedded within the fiber mat or that they at the most reach till the end of the fibers.

Such metallic hooks improve the cohesion of the composite design of metallic grid and fiber mat as well as its stability, too.

As metallic grid, metallic weaves, expanded metal, perforated metal sheets, tanged steels and the like are particularly suited. The metallic grid may have a larger facial extension than the fiber mat as such. This way, the projecting part(s) of the metallic grid can be used for the fastening of the heat shield, e.g. by connecting two such projecting parts to each other in case of a heat shield surrounding an object to be shielded completely.

The openings of the metallic grid may preferably be round or arbitrary polygons, for example triangular or square and even all kind of rectangular or rhombic shape, also pentagonal or hexagonal, in particular with the shape of a regular hexagon. In this respect, one or several openings of the metallic grid can be designed in this manner. It is however preferred if all openings of a metallic grid are designed identically with respect to their shape.

If cornered shapes are used for the passage openings of the metallic grid, then the corners can be rounded with corner radii R with 0.2 mm≦R≦1.0 mm, preferably 0.2 mm≦R≦0.5 mm. Such rounded corners cannot be avoided, especially as each technical “corner” at microscopical scale shows roundings for production purposes. Nevertheless, they are referred to as corners.

It is particularly advantageous to use such shapes for the opening of the metallic grid, which with a rotation by a particular angle can be transferred into themselves, e.g. equilateral triangles, quadrates, equilateral pentagons or hexagons and the like.

Metallic grids which have openings shaped with three aisles are particularly advantageous where the aisles of an opening are each arranged in the area between the aisles of another opening. Such structures can be adapted almost perfectly to three-dimensional surfaces.

Starting from the circumferential edge of the openings, it is particularly advantageous if protrusions protrude into the opening, which form a structure shaped like landing stages with a free end or bridges extending over the opening. These landing stages and bridges preferably protrude from the extension plane of the metallic grid into the one or the opposite direction. They this way serve for the clamping between the fibers of the fiber mat and the metallic grid. Here, one again has to take care that these protrusions and/or bridges protrude less far from the plane of the facial extension of the metallic grid than the fibers of the fiber mat, so that they are completely embedded within the fiber mat if one aims on an embodiment where the metallic grid has no direct contact with the part to be shielded. When the structures of the metallic grid have the shape of a landing stage, they can be bent with an angle at their free ends and this way possess an additional hook structure.

A mesh width of the openings of the metallic grid between 8 mm and 25 mm—in each case including or excluding the limits—has turned out as an advantageous mesh width for the heat shields according to the invention. In a variation of the heat shield according to the invention, heat shields are possible which also on the surface of the fiber layer facing the part to be shielded comprise a metallic lamination. In this case, one thus has a heat shield which comprises two metallic layers between which an insulating layer is arranged. This variant of the heat shield according to the invention is particularly suited to be mounted with a distance relative to the part to be shielded.

According to the invention, a shielded part with an area to be shielded is proposed, which comprises a heat shield according to the invention. The heat shield here is attached to the area to be shielded with the side of the fiber mat pointing away from the first metal sheet layer. In case of a direct insulation, no further intermediate layer is arranged between the fiber mat and the area to be shielded. It is however possible, but not preferred to provide further intermediate layers here, e.g. a further lamination of the heat shield. The installation of the heat shield on the area to be shielded can here be realized with positive fit or closely adjacent, in particular with a maximum distance of 3 mm, with this maximum distance being given over at least 75%, preferably over at least 90% of the contact surface. The contact surface is thus defined in such a way that no immediate contact has to be given.

In the following, several examples of heat shields according to the invention and of parts according to the invention. In these examples, the same or similar reference numbers are used for the same or similar elements, so that their explanation is not repeated in cases. The subsequent examples further comprise a plurality of additional characteristics, which can further enhance the invention. These additional characteristics may however not only be used exclusively in the combination shown in the respective example, but also insulated from each other or in combination with other characteristics in other examples.

It is shown in:

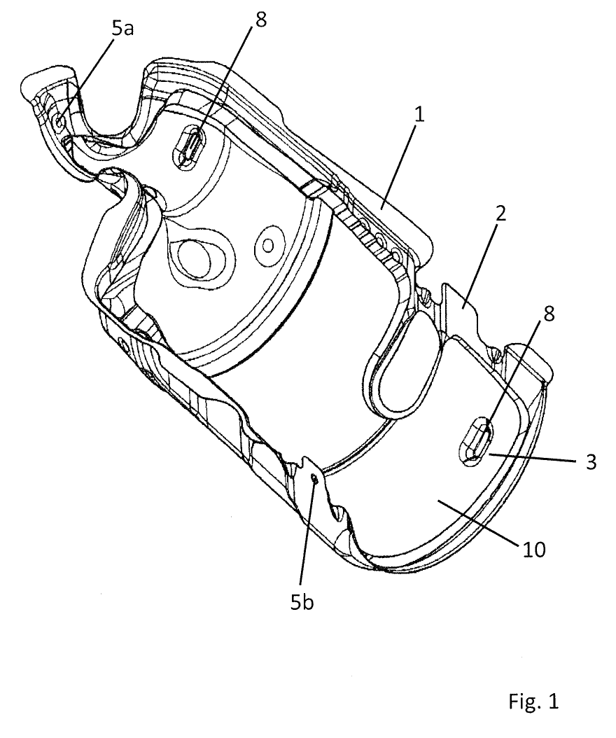

FIG. 1: A heat shield according to the invention;

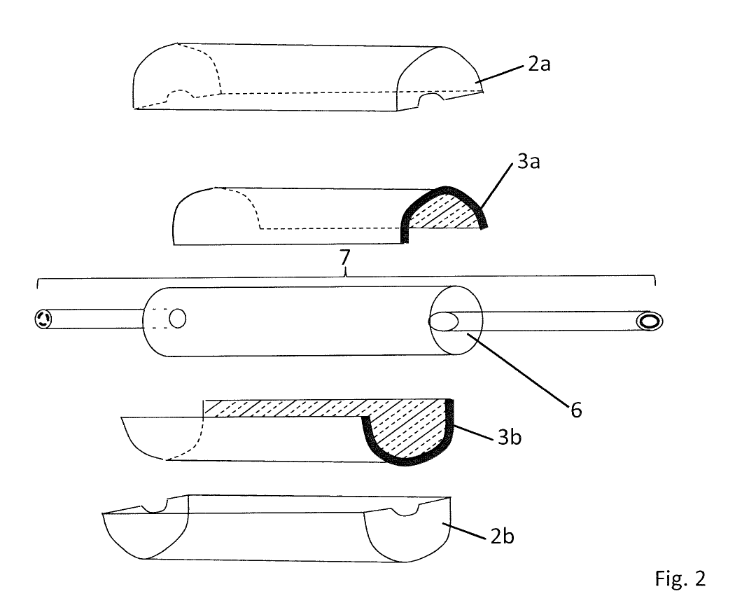

FIG. 2: A part shielded according to the invention in an exploded representation;

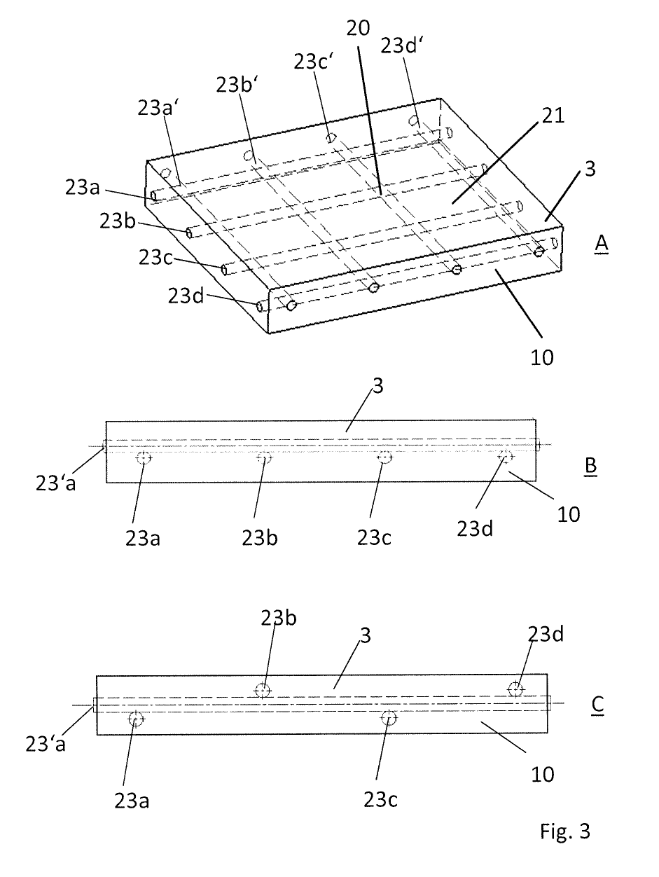

FIG. 3: Two variants of a heat shield according to the invention in a partial view;

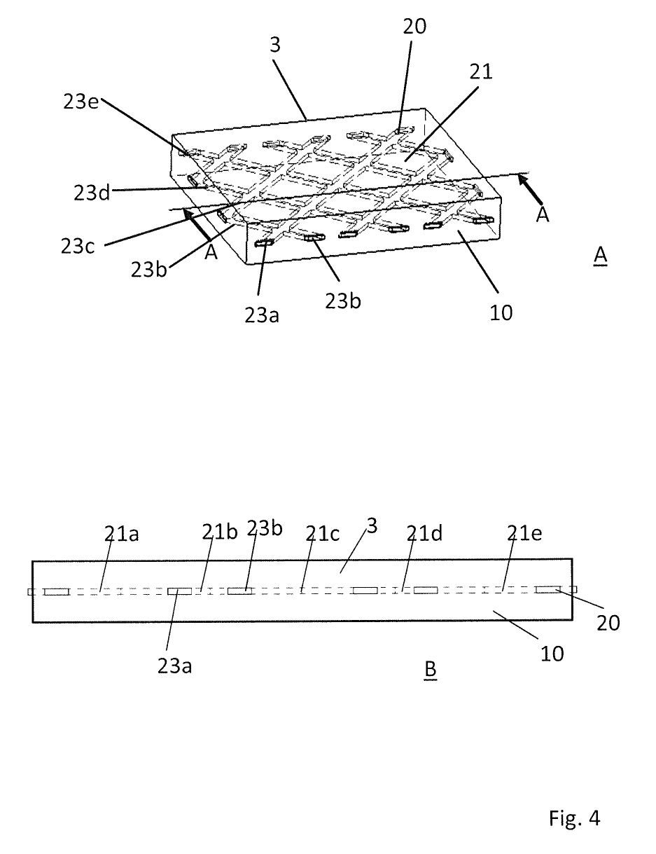

FIGS. 4 to 9: Sections of further heat shields according to the invention; and

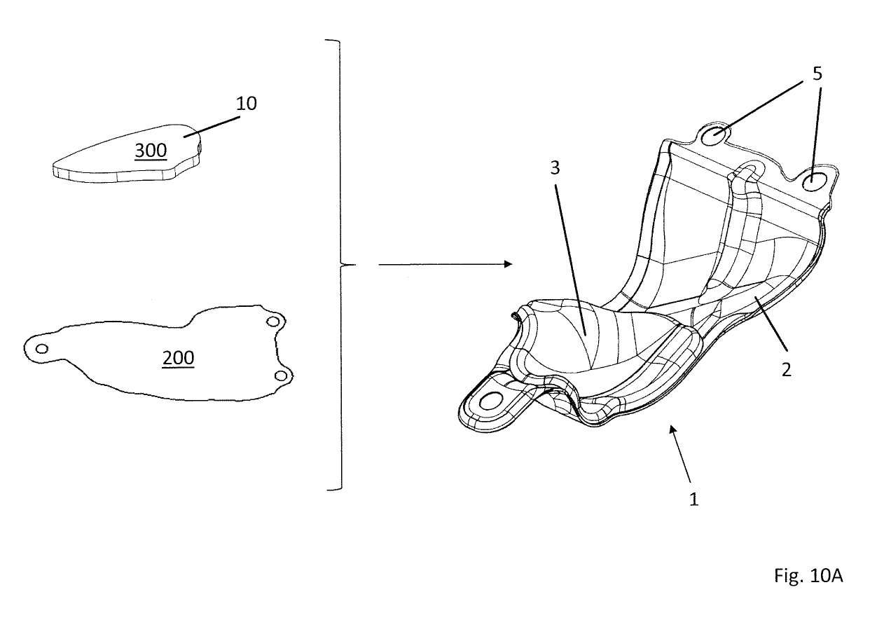

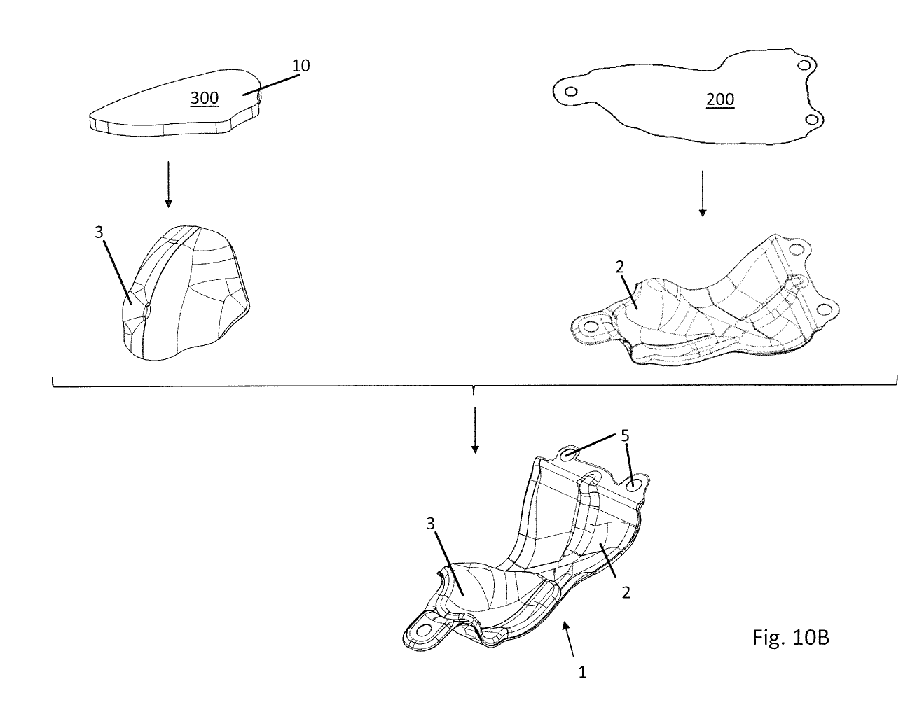

FIG. 10: two schemes for the production of heat shields according to the invention.

FIG. 1 shows a heat shield 1. This heat shield 1 comprises a metal sheet layer 2, which is adapted to the shape of the part to be shielded. In FIG. 1, the heat shield is shown in a top view to the inner side of the heat shield 1, which is arranged adjacent to the part to be shielded.

On this side, an insulating layer 3 is arranged adjacent to the metal sheet layer 2. Passage openings 5a, 5b for the fastening of the heat shield at the part to be shielded, using, e.g. screws, extend both through the metal sheet layer 2 and through the insulating layer 3. In addition, areas 8 are marked, in which the heat shield shows convexities. These areas 8 underline the complex total shape of the heat shield, which has to be realized by the insulating layer 3, too. According to the invention, the insulating layer comprises a metallic grid, which is embedded into a fiber mat 10, which fiber mat is visible from above in FIG. 1.

FIG. 2 shows a shielded part according to the present invention in an exploded view. The shielded part comprises a hot constructional element 6, e.g. an exhaust muffler or a catalyst. This hot constructional element 6 is part of an exhaust line 7 of a combustion engine.

FIG. 2 in an exploded view shows two half shells 3a and 3b of an insulating layer. On both these two half shells 3a and 3b, two half shells 2a and 2b of a metal sheet layer have been arranged. The layers 2a, 2b, 3a and 3b this way form the heat shield according to the invention.

The half shells 3a and 3b are realized as insulating layer, namely as fiber mat, into which a metallic grid is embedded. As is shown in FIG. 2, such an insulating layer can be shaped deliberately due to the embedded metallic grid and subsequent to this is able to maintain this shape.

The shape of the heat shield 2 shown in FIG. 2 as an example corresponds to a shape of low complexity. In particular with shapes with a plurality of recesses and protrusions, the embedding of a metallic grid provides considerable advantages during shaping and for the maintenance of this shape.

FIG. 3 in partial figures A to C shows different variants of an insulating layer 3 of a heat shield according to the invention.

In FIG. 3A, a section of an insulating layer 3 is illustrated in a top and transparent view. The insulating layer 3 comprises a fiber mat 10, into which a metallic grid 20 is embedded. The metallic grid 20 encloses openings 21, with the fibers of the fiber mat 10 penetrating the openings 21 and this way being embed in the metallic grid. The metallic grid is arranged approximately at the center with respect to the thickness of the insulating layer 3 and realized as metallic grid with longitudinal threads 23a to 23d and transverse threads 23a′ to 23d′.

In FIG. 3B, a cross-section through the insulating layer 3 from FIG. 3A is shown in a first variant. Here the longitudinal threads 23′a etc. each extend on one side of all transverse threads 23a to 23d within the insulating layer 3 and the fiber mat 10.

In FIG. 3C, a cross-section through FIG. 3A in a further variant is shown. In this case, a weave is given. The longitudinal fibers, as is shown for the longitudinal fiber 23a′, extend alternatingly above and below the transverse fibers, as is shown for the transverse fibers 23a to 23d, within the insulating layer 3 and within the fiber weave 10.

FIG. 4A shows a further section of an insulating layer 3 in a transparent view. The insulating layer 3 comprises a fiber mat 10, which is embedded in a grid of expanded metal. The grid of expanded metal now comprises longitudinal bridges 23a, 23c and transversal bridges 23b, 23d and 23e. These bridges form rhombic passage openings 21 between the bridges.

FIG. 4B shows a cross-section through the insulating layer 3 in FIG. 4A along section A-A. Here, a total of five of the rhombic passage openings 21a to 21e are marked with reference numbers.

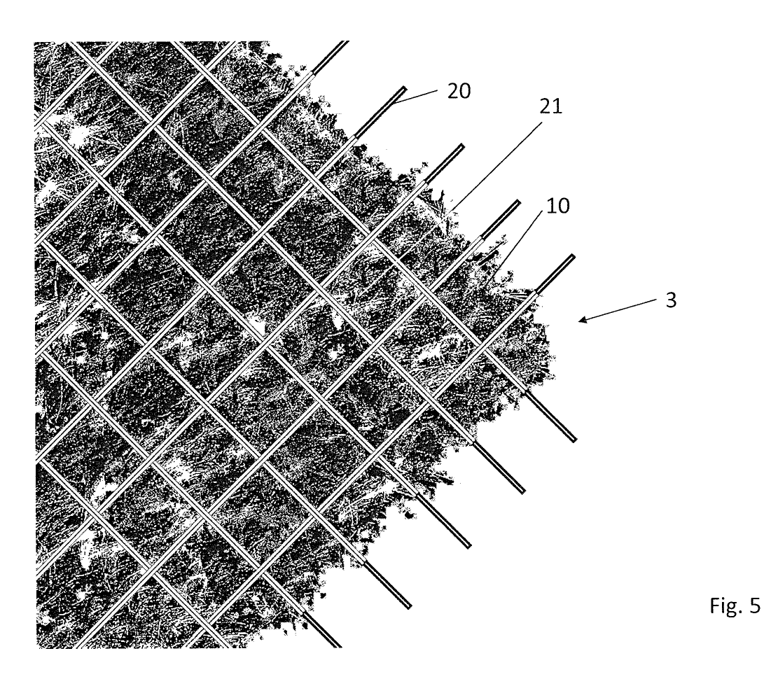

FIG. 5 shows a top-view to an insulating layer 3, as it is illustrated in FIG. 3C in cross-section. The insulating layer 3 comprises a woven grid 20, which is embedded into a fiber mat 10. The second fiber mat, which is applied to the metal grid 20 from the upper side, is not shown. The fixation of both fiber mats through the woven grid 20 can for instance be realized during the shaping of the insulating layer 3 or also using a needle process. The woven grid 20 therefore is located centrally in the insulating layer 20 comprising the two fiber mats.

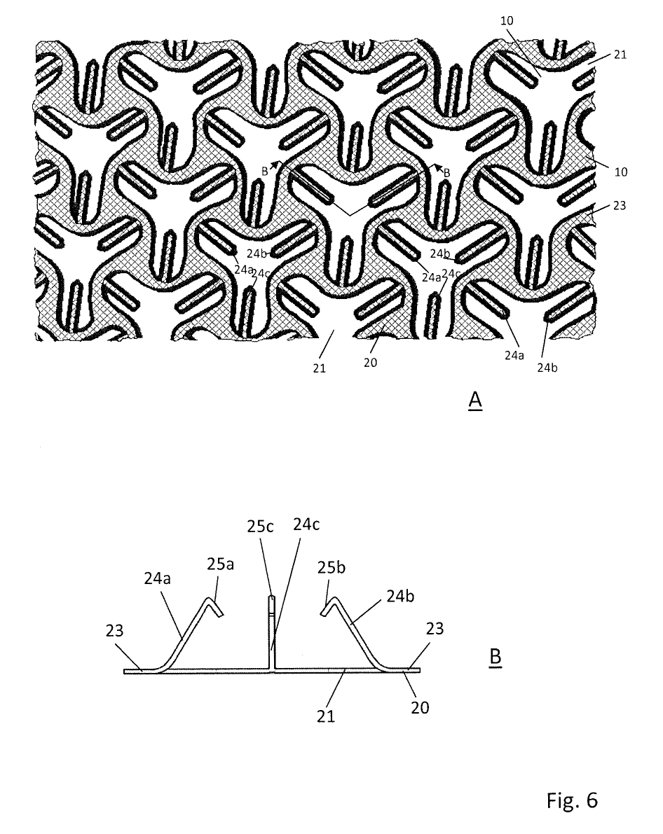

FIG. 6 in partial figures A and B shows the design of a metallic grid 20 according to the invention. The metallic grid 20 comprises passage openings 21, which show a form with three aisles. Each aisle of an opening here is arranged between two aisles of an adjacent opening, so that arch-shaped bridges 23 result between the aisles. The bridges 23 and the entire grid 20 can easily be deformed three-dimensionally, so that it can be adapted to each three-dimensional shape in an almost ideal manner, e.g. to the metal sheet layer of the heat shield. Within each of the aisles of the openings 21, protrusions 24a, 24b having a general shape of landing stages with hook-shaped free ends are arranged which start from bridges. They extend freely into the opening, and, as shown in FIG. 6B in cross-section along section B-B in FIG. 6A are bent from the plane of the metallic grid 20 with an angle. The angle can amount to e.g. 70° as shown or up to 90°. An almost orthogonal passage of the bridges, thus an angle close to 90° is preferred in this respect. At their ends, they comprise a hook-shaped element 25a, 25b, 25c, so that the hooks 24a to 24c can get caught with the fibers of the fiber mat 10 passing through the passage openings 21. This way, the grid is securely held in the fiber mat 10 and embedded into the latter.

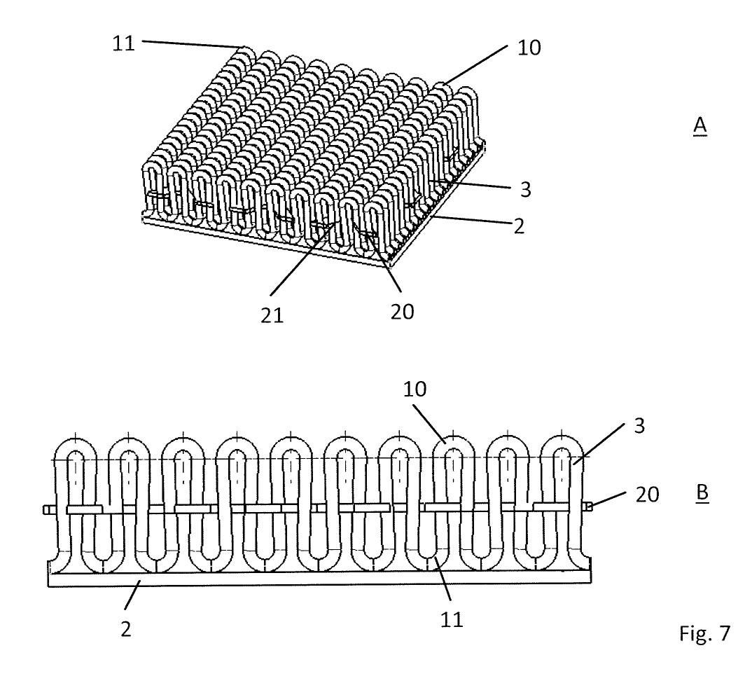

FIG. 7 in partial figures A and B shows a top-view to and a cross-section through an insulating layer 3 and a metallic layer 2 of a heat shield according to the invention.

While in the preceding examples, the fiber mat 10 was realized as pile, in this example the fiber mat 10 is realized as an arrangement of loops. The loops here pass both through the passage openings 21 as well as through the bridges of the grid 20. This way, the grid is anchored in an ideal manner within the fiber mat 10; in the present example it is arranged approximately in the middle.

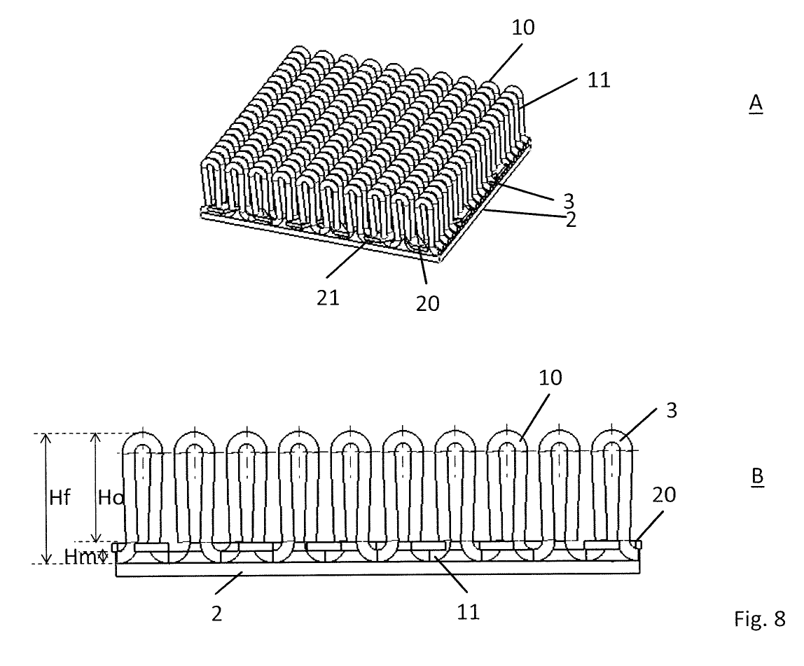

In FIG. 8, in partial figures A and B, a further embodiment of an insulating layer 3 of a heat shield according to the invention is shown together with the metallic layer 2 in top-view and cross-section. While the metallic grid is arranged approximately centered relative to the thickness of the fiber mat 10 in FIG. 7, the metallic grid 20 in FIG. 8 is arranged outside of the center of the fiber mat 10 relative to its thickness Hf, namely closer to the metallic layer 2 of the heat shield according to the invention. In the example of FIG. 8, the metallic grid 20 nevertheless is also embedded into the fiber mat 10, but relative to the thickness, a larger part of the fiber mat is given one-sided in the direction of the part to be shielded, thus distanced to the metallic layer 2. Relative to the thickness Hf of the fiber mat 10, the metallic grid 20 in FIG. 8 is arranged distanced by about Hm=10% from the surface of the fiber mat 10 facing the metallic layer 2. The distance Ho from the surface of the fiber mat pointing away from the metallic layer 2 here amounts to more than 80% of the thickness Hf of the fiber mat 10.

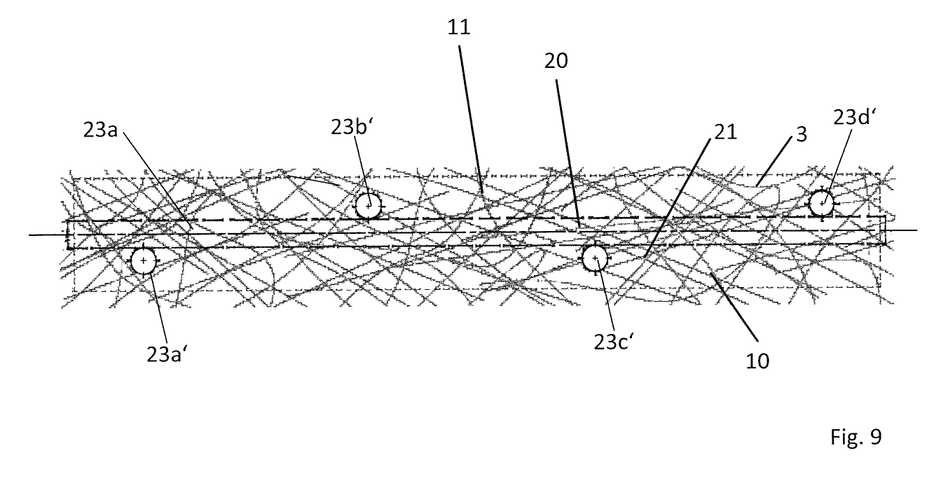

FIG. 9 shows a further embodiment of an insulating layer 3 of a heat shield 1 according to the invention. Here, the fibers 11 of the fiber mat 10 are loosely filled into the passage openings 21 of the metallic grid 20, which is designed comparable to FIG. 10. The illustration does not reflect the actual density of the fibers 11, in order to remain clear. An advantageous production of this embodiment of the insulating layer 3 results, when the fibers 11 are blown into the metallic grid 20. Here, a densification of the fiber-metal grid-composite in its plane can take place during the reshaping of the insulating mat 3, so that an improved long-term stability of the insulating layer 3 results.

FIG. 10 in two partial FIGS. 10A and 10B illustrates schematically the major ways to produce the heat shield 1 from a metal sheet blank 200 and a blank 300 of the insulation layer based on a fiber mat 10 with an embedded metallic grid. In the approach of FIG. 10A, the blanks are put one on the other and then jointly deformed to make a heat shield 1 with a metal sheet layer 2 and an insulating layer 3. In the approach of FIG. 10B, the two flanks 200, 300 are deformed individually and then put together in order to make a heat shield 1 with a metal sheet layer 2 and an insulating layer 3. In both cases, the metal sheet layer 2 shows a larger extension than the insulating layer 3.

1-21. (canceled)

22. A heat shield for shielding of hot areas of a combustion engine comprising:
at least one metal sheet layer;
an insulating layer arranged adjacent to the metal sheet layer,
wherein the insulating layer comprises a metallic grid, which is embedded into a fiber mat.

23. The heat shield according to claim 22, wherein at least a part of the fibers of the fiber mat penetrates openings of the metallic grid.

24. The heat shield according to claim 22, wherein the metallic grid relative to the respective local thickness of the fiber mat is distanced to the surface of the fiber mat facing the metal sheet layer by at least 5% of the thickness of the fiber mat and/or to the surface of the fiber mat pointing away from the metal sheet layer by at the most 35% of the thickness of the fiber mat and the metallic grid.

25. The heat shield according to claim 22, wherein the thickness of the fiber mat is ≧4.5 mm and ≦15 mm.

26. The heat shield according to claim 22, wherein the fiber mat comprises at least one of glass fibers, mineral fibers and carbon fibers.

27. The heat shield according to claim 26, wherein the fibers of the fiber mat as fiber pile or fiber loop penetrate the metallic grid orthogonal to its facial extension or are interwoven with the metallic grid.

28. The heat shield according to claim 26, wherein the fibers are adhesively bonded to the metallic grid.

29. The heat shield according to claim 26, wherein the fibers of the fiber mat in individual areas or throughout the fiber mat are fixed with a binder.

30. The heat shield according to claim 29, wherein the fibers of the fiber mat are fixed with the binder in edge regions.

31. The heat shield according to claim 29, wherein the fibers of the fiber mat are fixed with the binder in areas close to surfaces of the fiber mat.

32. The heat shield according to claim 29, wherein the binder content in the fiber mat is ≦25% of the total weight of the fiber mat.

33. The heat shield according to claim 22, wherein the fiber mat contains no binder.

34. The heat shield according to claim 26, wherein one, several or all of the fibers comprise one or several metallic fibers as core.

35. The heat shield according to claim 26, wherein free ends of the fibers engage behind bridges of the metallic grid.

36. The heat shield according to claim 26, wherein hooks protrude from the metallic grid, the hooks engage behind the fibers of the fiber mat, with the hooks protruding less far from the plane of facial extension of the metal grid than the fibers of the fiber mat.

37. The heat shield according to claim 22, wherein the metallic grid is a metallic weave, expanded metal sheet, perforated metal sheet, or tanged metal sheet.

38. The heat shield according to claim 23, wherein at least one opening of the metallic grid is round, triangular, square, rhombic or hexagonal.

39. The heat shield according to claim 38, wherein at least one opening of the metallic grid is shaped as a regular hexagon where the corners are rounded with corner radii R with 0.2 mm≦R≦1.0 mm.

40. The heat shield according to claim 23, wherein at least one of the openings of the metallic grid in a top view to the openings show a regular shape, which can be transferred into itself with a rotation around its central axis by 360°/n with n being a natural number.

41. The heat shield according to claim 23, wherein at least one opening of the metallic grid in a top view to the openings have the basic shape of a polygon with protrusions protruding from the sides of the polygon into the opening, where the protrusions are designed as hooks, which engage behind the fibers of the fiber mat, where the hooks protrude less far from the plane of facial extension of the metallic grid than the fibers of the fiber mat.

42. The heat shield according to claim 23, wherein the mesh width of the openings of the metallic grid is ≧8 mm and ≦25 mm.

43. The heat shield according to claim 22, wherein the fiber mat is a weave selected from the group of a loop weave, a pile, a knitted fabric, a warp knitted fabric, a roving or a fleece.

44. The heat shield according to claim 43, wherein the fiber mat is
a) a loop weave with a density in loops of ≧2/cm² and ≦30/cm² or
b) a pile with a fiber density in erected fibers of ≧9/cm² and 100/cm².

45. The heat shield according to claim 22, wherein a side of the fiber mat pointing away from the metal sheet layer rests on the area to be shielded or is arranged at least adjacent to the area to be shielded with a maximum distance of ≦3 mm over at least 75% of the contact surface.
